(19) United States
(12) Patent Application Publication
(10) Pub. No.: US 2024/0234895 A1
(43) Pub. Date: Jul. 11, 2024

(54) STRUCTURAL BATTERY PACK ADHESIVE COATING STACKUP

(71) Applicant: Apple Inc., Cupertino, CA (US)

(72) Inventors: Edward T Hillstrom, Vancouver (CA); Nivay Anandarajah, San Leandro, CA (US); Christopher T Campbell, San Jose, CA (US); Dustin Y Chen, Saratoga, CA (US); Joseph D Rainey, Sunnyvale, CA (US); Dylan C Erb, San Jose, CA (US); Rebecca L King, Capitola, CA (US); Evan D Maley, Redwood City, CA (US)

(21) Appl. No.: 18/376,365

(22) Filed: Oct. 3, 2023

Related U.S. Application Data
(63) Continuation-in-part of application No. 18/151,960, filed on Jan. 9, 2023.

(51) Int. Cl. H01M 50/24; H01M 10/653; H01M 50/103; H01M 50/15; H01M 50/209

(52) U.S. Cl. CPC H01M 50/24; H01M 10/653; H01M 50/103; H01M 50/15; H01M 50/209

(57) ABSTRACT

A battery pack includes an enclosure comprising a first wall and a second wall opposing the first wall, battery cells disposed in an interior of the enclosure between the first wall and the second wall, a first coating and adhesive assembly, and a second coating and adhesive assembly. The first coating and adhesive assembly is configured to structurally couple the battery cells with the first wall of the enclosure and electrically isolate the battery cells from the first wall of the enclosure. The second coating and adhesive assembly is configured to structurally coupling the battery cells with the second wall of the enclosure and electrically isolate the battery cells from the second wall of the enclosure.

### CROSS-REFERENCE TO RELATED APPLICATIONS

This application is a continuation-in-part of U.S. patent application Ser. No. 18/151,960, filed Jan. 9, 2023, entitled “STRUCTURAL BATTERY PACK WITH ADHESIVE COATING STACKUP,” which is hereby incorporated by reference in its entirety for all purposes.

### BACKGROUND

The present disclosure relates generally to a battery pack, and more specifically to adhesives and coatings employed to structurally couple and electrically isolate battery cells of the battery pack from walls of an enclosure of the battery pack.

A battery pack may include a number of battery cells, such as lithium-ion battery cells, configured to generate a charge having a voltage and current for powering a load. For example, the battery cells may be coupled in series such that individual voltages of the battery cells are combined to generate a charge having a total voltage, or in parallel such that individual currents of the battery cells are combined to generate a charge having a total current. In some embodiments, series and parallel couplings are employed between various battery cells of the battery pack to generate a total voltage and total current compatible with the load receiving the charge.

Certain battery packs may be employed to power systems having large and heavy componentry. In traditional configurations, the battery pack may be ill equipped to support large mechanical loads (e.g., forces) corresponding to the componentry of the system being powered by the battery pack. Integration of the traditional battery pack with the system may be limited by this inability to support such large mechanical loads. Additionally or alternatively, heat transfer from the traditional battery pack to an external environment may be limited by this inability to support such large mechanical loads. Accordingly, it is now recognized that improved battery packs are desired.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a battery pack includes an enclosure comprising a first wall and a second wall opposing the first wall, battery cells disposed in an interior of the enclosure between the first wall and the second wall, a first coating and adhesive assembly, and a second coating and adhesive assembly. The first coating and adhesive assembly is configured to structurally couple the battery cells with the first wall of the enclosure and electrically isolate the battery cells from the first wall of the enclosure. The second coating and adhesive assembly is configured to structurally coupling the battery cells with the second wall of the enclosure and electrically isolate the battery cells from the second wall of the enclosure.

In another embodiment of the present disclosure, a battery pack includes a stacked assembly configured to support a mechanical load on the battery pack. The stacked assembly includes an enclosure configured to receive battery cells, an enclosure coating disposed on an inside of the enclosure, a battery cell, a cell coating disposed on the battery cell, and a structural adhesive disposed between a first cell coating portion of the cell coating and a first enclosure coating portion of the enclosure coating. The stacked assembly also includes a thermal adhesive disposed between a second cell coating portion of the cell coating and a second enclosure coating portion of the enclosure coating. The stacked assembly also includes a heat exchanger forming a portion of the enclosure or coupled to the enclosure such that the second enclosure coating portion is between the heat exchanger and the thermal adhesive.

In yet another embodiment of the present disclosure, a battery pack includes a first wall of an enclosure, a first enclosure coating portion contacting the first wall of the enclosure, a structural adhesive contacting the first enclosure coating portion, a first battery cell coating portion contacting the structural adhesive, a battery cell contacting the first battery cell coating portion, and a second battery cell coating portion contacting the battery cell. The battery pack also includes a thermal adhesive contacting the second battery cell coating portion, a second enclosure coating portion contacting the thermal adhesive, and a second wall of the enclosure contacting the second enclosure coating portion.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a schematic diagram of a battery pack having an enclosure, battery cells disposed in the enclosure, a first coating and adhesive assembly, and a second coating and adhesive assembly, according to embodiments of the present disclosure;

FIG. 2 is an exploded perspective view of the battery pack of FIG. 1, according to embodiments of the present disclosure;

FIG. 3 is a cross-sectional view of the battery pack of FIG. 1, according to embodiments of the present disclosure;

FIG. 4 is a blown up cross-sectional view of the first coating and adhesive assembly of the battery pack of FIG. 1, according to embodiments of the present disclosure;

FIG. 5 is an exploded perspective view of a battery cell of the battery pack of FIG. 1, according to embodiments of the present disclosure;

FIG. 6 is a schematic cross-sectional view of a portion of the battery pack of FIG. 1, including the battery cell of FIG. 5, according to embodiments of the present disclosure;

FIG. 7 is an exploded side view of a portion of the battery pack of FIG. 1, including a portion of a battery cell, a portion of a battery cell coating, and a portion of adhesive, according to embodiments of the present disclosure;

FIG. 8 is a perspective view of a lid of an enclosure of the battery pack of FIG. 1, according to embodiments of the present disclosure;

FIG. 9 is a perspective view of a base of an enclosure of the battery pack of FIG. 1, in which portions of the base are coated with an enclosure coating, according to embodiments of the present disclosure;

FIG. 10 is a perspective view of a base of an enclosure of the battery pack of FIG. 1, in which the base is coated with an enclosure coating, according to embodiments of the present disclosure;

FIG. 11 is a process flow diagram illustrating a method of manufacturing and assembly portions of the battery pack of FIG. 1, according to embodiments of the present disclosure;

FIG. 12 is a process flow diagram illustrating another method of manufacturing and assembling portions of the battery pack of FIG. 1, according to embodiments of the present disclosure;

FIG. 13 is a perspective view of the battery cell of FIG. 5 in an assembled form, according to embodiments of the present disclosure;

FIG. 14 is an exploded perspective view of a battery cell of the battery pack of FIG. 1, including broadside coating segments overwrapped by high quality coating segments, according to embodiments of the present disclosure;

FIG. 15 is a perspective view of the battery cell of FIG. 14 in an assembled form, according to embodiments of the present disclosure;

FIG. 16 is an exploded perspective view of a battery cell of the battery pack of FIG. 1, including an end cap with apertures configured to receive terminals of the battery cell, according to embodiments of the present disclosure;

FIG. 17 is a perspective view of the battery cell of FIG. 16 in an assembled form, according to embodiments of the present disclosure;

FIG. 18 is an exploded perspective view of a battery cell of the battery pack of FIG. 1, including an end cap with apertures configured to receive terminals of the battery cell, and including at least one thermal insulation or gap pad, according to embodiments of the present disclosure;

FIG. 19 is a perspective view of the battery cell of FIG. 18 in an assembled form, according to embodiments of the present disclosure;

FIG. 20 is a perspective view of a battery cell of the battery pack of FIG. 1, including UV cured spray acrylic in at least a portion of a battery cell coating of the battery cell, according to embodiments of the present disclosure; and

FIG. 21 is a process flow diagram illustrating a method of manufacturing a battery cell of the battery pack of FIG. 1, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is generally directed to a battery pack. More specifically, the present disclosure is directed to a battery pack having various features configured to structurally couple battery cells of the battery pack with opposing walls of an enclosure of the battery pack, and electrically isolate the battery cells from the enclosure.

For example, the battery pack may include a stacked assembly extending from a first wall of an enclosure of the battery pack to a second wall of the enclosure of the battery pack, where the stacked assembly is configured to support a relatively large mechanical load against the enclosure, such as against the first wall of the enclosure. In general, the stacked assembly is configured to structurally couple battery cells of the battery pack with the enclosure of the battery pack, such that mechanical loads are distributed or transmitted to the battery cells. The enclosure may include, for example, a base configured to receive the battery cells of the battery pack, and a lid configured to couple to the base to enclose the battery cells within the enclosure. The lid may correspond to the first wall of the stacked assembly described above, and the base may include the second wall of the stacked assembly described above. In some embodiments, a heat exchanger may be formed in or attached to the second wall.

The stacked assembly may also include an enclosure coating on the first wall and the second wall of the enclosure. The enclosure coating may include, for example, an electrocoating layer contacting surfaces of the first wall and the second wall facing the enclosure interior, a powder coating layer contacting the electrocoating layer, or both. The stacked assembly may also include a structural adhesive disposed between the first wall of the enclosure and the battery cells within the enclosure interior. For example, the structural adhesive may contact a first portion of the enclosure coating, where the first portion of the enclosure coating is disposed on the first wall of the enclosure. The stacked assembly may also include a thermal adhesive disposed between the second wall of the enclosure and the battery cells within the enclosure interior. For example, the thermal adhesive may contact a second portion of the enclosure coating, where the second portion of the enclosure coating is disposed on the second wall of the enclosure.

Further, aspects of the battery cells may also form one or more portions of the stacked assembly described above. For example, each battery cell may include a can in which various componentry of the battery cell (e.g., electrodes, electrolyte, separator) is disposed. A cell coating may be disposed about the can of the battery cell, where a first portion of the cell coating contacts the structural adhesive and a second portion of the cell coating contacts the thermal adhesive. The battery cell itself may also be considered a part of the stacked assembly.

In general, the above-described features are configured to structurally couple the battery cells with the first wall and the second wall of the enclosure, electrically isolate the battery cells from the enclosure, and/or promote heat transfer from the battery cells toward, for example, a heat exchanger formed in (or attached to) the second wall of the enclosure. These and other related features (e.g., materials selections, surface preparations of various aspects of the stacked assembly, manufacturing and/or assembly processes, etc.) will be described in detail below with reference to the drawings.

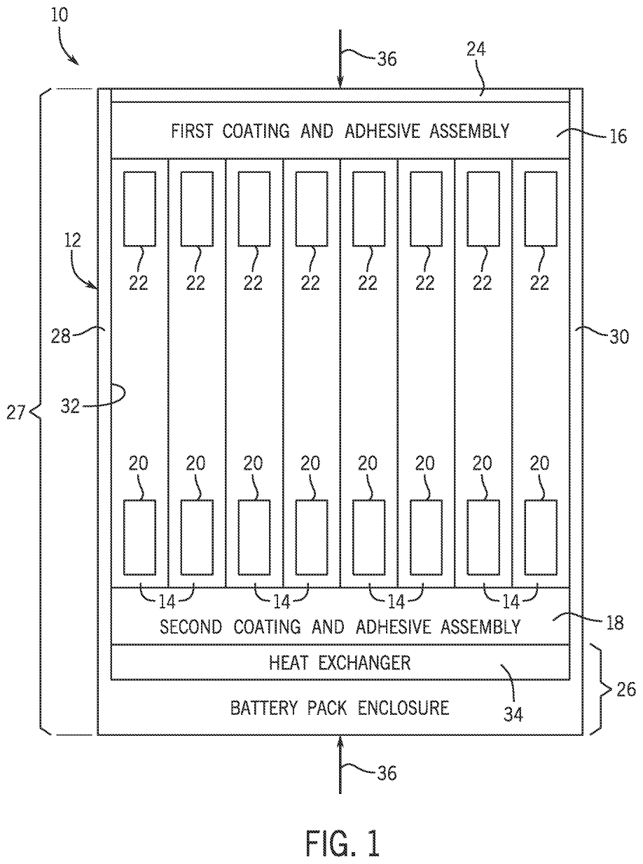

FIG. 1 is a schematic diagram of an embodiment of a battery pack 10 having an enclosure 12, battery cells 14 disposed in the enclosure 12, a first coating and adhesive assembly 16, and a second coating and adhesive assembly 18. The battery cells 14, sometimes referred to as electrochemical cells, may include lithium-ion (Li-ion) cells (e.g., lithium iron phosphate (LFP) cells), nickel-metal hydride (NiMH) cells, nickel-cadmium (NiCd) cells, lead-acid cells, or other types of rechargeable, secondary battery cells. Each battery cell 14 may include a first terminal 20 and a second terminal 22 employed to electrically couple the battery cells 14 together (e.g., via bus bars). For example, the battery cells 14 may be coupled in series such that individual voltages of the battery cells 14 are combined to generate a charge having a total voltage, or in parallel such that individual currents of the battery cells 14 are combined to generate a charge having a total current. In some embodiments, series and parallel couplings are employed between various battery cells 14 of the battery pack 10 to generate a total voltage and total current compatible with the load receiving the charge.

In the illustrated embodiment, the enclosure 12 includes a first wall 24, a second wall 26 opposing the first wall 24, a third wall 28 extending between the first wall 24 and the second wall 26, and a fourth wall 30 opposing the third wall 28 and extending between the first wall 24 and the second wall 26. Of course, any suitable number of walls, including fifth and sixth walls, may also be employed and are not shown in the illustrated embodiment. In general, the enclosure 12 defines an enclosure interior 32 configured to receive the battery cells 14, the first coating and adhesive assembly 16, and the second coating and adhesive assembly 18. For example, the second wall 26, the third wall 28, and the fourth wall 30 may form a base of the enclosure 12, where the base is configured to receive the battery cells 14, the first coating and adhesive assembly 16, and the second coating and adhesive assembly 18. The first wall 24 of the enclosure 12 may be a lid (e.g., formed by an aluminum or aluminum alloy, such as 5182 aluminum alloy) configured to couple to the base (e.g., to the third wall 28 and the fourth wall 30 of the enclosure 12) to enclose the battery cells 14, the first coating and adhesive assembly 16, and the second coating and adhesive assembly 18 within the enclosure 12. In some embodiments, a heat exchanger 34 may be formed in (or attached to) the second wall 26 of the enclosure 12.

The first coating and adhesive assembly 16 may be configured to extend from the first wall 24 of the enclosure 12 to the battery cells 14. In some embodiments, a portion of each battery cell 14 (e.g., a portion of a cell coating) may form a part of the first coating and adhesive assembly 16. In general, the first coating and adhesive assembly 16 may be configured to structurally couple the battery cells 14 with the first wall 24 (e.g., the lid) of the enclosure 12. Further, the first coating and adhesive assembly 16 may be configured to electrically isolate the battery cells 14 from the first wall 24 of the enclosure 12. As described in detail with reference to later drawings, the first coating and adhesive assembly 16 may include an enclosure coating contacting the first wall 24 (e.g., the lid) of the enclosure 12, a structural adhesive contacting the enclosure coating, and cell coating portions of the cell coatings corresponding to the battery cells 14.

The second coating and adhesive assembly 18 may be configured to extend from the second wall 26 of the enclosure 12 to the battery cells 14. In some embodiments, a portion of each battery cell 14 (e.g., a portion of a cell coating) may form a part of the second coating and adhesive assembly 18. In general, the second coating and adhesive assembly 18 may be configured to structurally couple the battery cells 14 with the second wall 26 of the enclosure 12, electrically isolate the battery cells 14 from the second wall 26 of the enclosure 12, and promote heat transfer from the battery cells 14 toward the heat exchanger 34 formed in (or attached to) the second wall 26 of the enclosure 12. As described in detail with reference to later drawings, the second coating and adhesive assembly 18 may include an enclosure coating contacting the second wall 26 of the enclosure 12, a thermal adhesive contacting the enclosure coating, and cell coating portions of the cell coatings corresponding to the battery cells 14.

The first coating and adhesive assembly 16, the battery cells 14, and the second coating and adhesive assembly 18 may be configured to enable the battery pack 10 to support a mechanical load 36 against the first wall 24 and/or the second wall 26 of the enclosure 12. That is, a stacked assembly 27 of the battery pack 10, which may include the first wall 24, the first coating and adhesive assembly 16, the battery cells 14, the second coating and adhesive assembly 18, may be configured to support the mechanical load 36. In general, the battery cells 14 may be structurally coupled to the enclosure 12 such that the mechanical load(s) 36 are supported be (e.g., transmitted to) the battery cells 14.

The stacked assembly 27 may include a cross-section having a first segment extending from the first wall 24 to the battery cells 14, and having a second segment extending from the second wall 26 to the battery cells 14, where the first segment and the second segment of the cross-section are substantially devoid of gaps. In this way, the mechanical load(s) 36 against the first wall 24 and/or second wall 26 of the enclosure 12 may be transmitted to the battery cells 14, which include cans (e.g., aluminum or aluminum alloy cans, such as 3003 aluminum alloy cans) substantially capable of providing support against the mechanical load(s) 36. As an example, the mechanical load 36 may correspond to those associated with vehicles, such as a weight of a seat, a weight of an occupant, a combined weight of the seat and occupant, dynamic loads associated with movement of the vehicle, etc. As described in detail below with reference to later drawings, aspects of the above-described features, such as materials, spatial arrangement, surface preparations, and the like, may contribute to an ability of the battery pack 10 to support the mechanical load(s) 36.

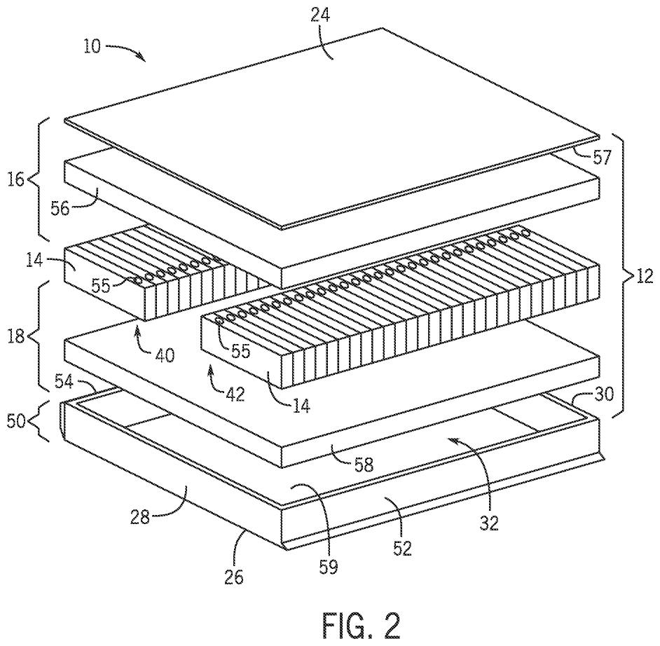

FIG. 2 is an exploded perspective view of an embodiment of the battery pack 10 of FIG. 1. In the illustrated embodiment, the battery pack 10 includes the enclosure 12 and the battery cells 14 configured to be disposed in the enclosure interior 32 defined by the enclosure 12. As shown, the battery cells 14 may be arranged in a first stack 40 and a second stack 42, although other arrangements are also possible. As previously described, the enclosure 12 may include the first wall 24 (e.g., a lid) and a base 50 including the second wall 26 opposing the first wall 24, the third wall 28, and the fourth wall 30. As shown, the base 50 may also include a fifth wall 52 and a sixth wall 54 opposing the fifth wall 52. In this way, the base 50 may include, in some embodiments, a substantially rectangular shape formed by the third wall 28, the fourth wall 30, the fifth wall 52, and the sixth wall 54. Although not shown in the illustrated embodiment, the battery cell terminals 20, 22 illustrated in FIG. 1 may face the fifth wall 52 and/or the sixth wall 54 of the base 50 of the enclosure 12 in certain embodiments. Further, voltage sense tabs 55 of the battery cells 14 may face, for example, the first wall 24 (e.g., lid) of the enclosure 12, and may be configured to couple with a printed circuit board (PCB) (not shown) of the battery 10.

As previously described, the battery pack 10 may include the first coating and adhesive assembly 16 and the second coating and adhesive assembly 18. As shown, the first coating and adhesive assembly 16 may include a structural adhesive 56 extending between the first wall 24 (e.g., lid) of the enclosure 12 and the battery cells 14 of the battery pack 10. The structural adhesive 56 may, for example, contact an enclosure coating disposed on an inward facing surface 57 (e.g., facing the enclosure interior 32 and battery cells 14 disposed therein) of the first wall 24. Further, the structural adhesive 56 may contact various battery cell coatings disposed about the battery cells 14 of the battery pack 10. The structural adhesive 56, enclosure coating, and battery cell coatings will be described in detail with reference to later drawings.

As shown, the second coating and adhesive assembly 18 may include a thermal adhesive 58 extending between the second wall 26 of the enclosure 12 and the battery cells 14 of the battery pack 10. The thermal adhesive 58 may, for example, contact an enclosure coating disposed on an inward facing surface 59 (e.g., facing the enclosure interior 32 and battery cells 14 disposed therein) of the second wall 26. Further, the thermal adhesive 58 may contact various battery cell coatings disposed about the battery cells 14 of the battery pack 10. In some embodiments, the thermal adhesive 58 may be configured to promote heat transfer from the battery cells 14 to a heat exchanger (not shown) formed in or otherwise attached to the second wall 26 of the enclosure 12. The thermal adhesive 58, enclosure coating, and battery cell coatings will be described in detail with reference to later drawings.

In some embodiments, the structural adhesive 56 corresponding to the first coating and adhesive assembly 16 and the thermal adhesive 58 corresponding to the second coating and adhesive assembly 18 may include the same or similar materials. In other embodiments, the structural adhesive 56 may include a material composition different than the thermal adhesive 58. In general, the adhesives 56, 58 may include materials selected from 2 component polyurethanes (2KPU), 2 component acrylics (2K acrylic), or 2 component epoxy (2K epoxy). Further, the structural adhesive 56 or corresponding material may include a thermal conductivity (i.e., K-value) between 0.1 and 1.0, 0.15 and 0.6, or 0.2 and 0.4, a strength (e.g., shear strength) of 5-9 Megapascals (MPa), and an elongation percentage between 50% and 200% or between 100% and 175%. Additionally or alternatively, the thermal adhesive 58 or corresponding material may include a thermal conductivity (i.e., K-value) between 0.2 and 2.0, 0.3 and 1.5, or 0.4 and 1.0, a strength (e.g., shear strength) of 5-9 MPa, and an elongation percentage between 50% and 150% or between 75% and 125%. Other embodiments in accordance with the present disclosure may differ.

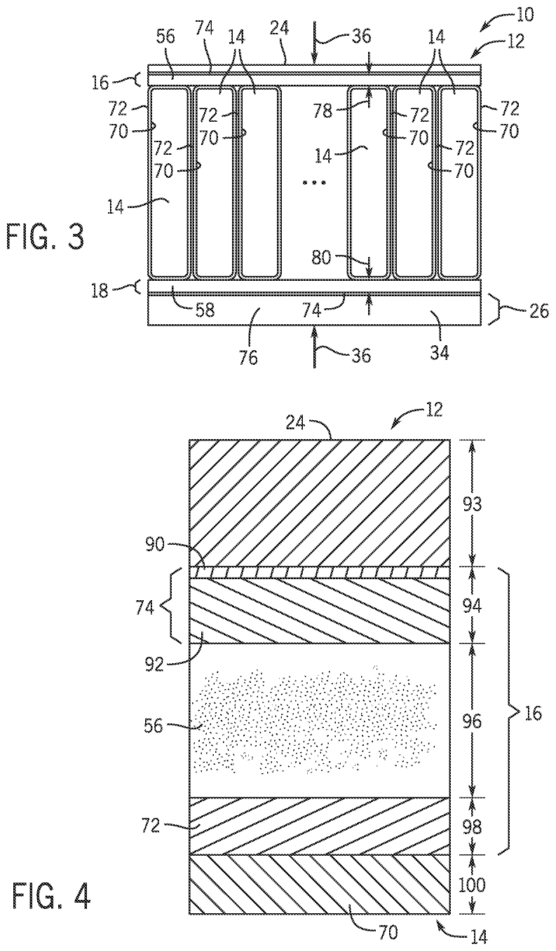

FIG. 3 is a cross-sectional view of an embodiment of the battery pack 10 of FIG. 1. In the illustrated embodiment, the battery pack 10 includes the first coating and adhesive assembly 16 extending from the first wall 24 of the enclosure to the battery cells 14 of the battery pack 10. Each battery cell 14 may include a can 70 (e.g., aluminum or aluminum alloy can, such as 3003 aluminum alloy can) configured to house various componentry of the battery cell 14, such as electrodes, electrolyte, and a separator. Further, a battery cell coating 72 may be disposed about each battery cell 14 of the battery pack 10. The battery cell coating 72 may include, for example, polyethylene terephthalate (PET). In some embodiments, each battery cell coating 72 may additionally or alternatively include acrylic. In some embodiments, multiple types of PET (e.g., including differences in material composition, additives, coating adhesives, or surface preparation) may be employed for each battery cell coating 72. In any of the above-described embodiments, each battery cell coating 72 may include at least a portion that is UV cured.

The battery cell coating 72 may form a portion of the first coating and adhesive assembly 16 extending from the first wall 24 of the enclosure to the battery cells 14. As previously described, the first coating and adhesive assembly 16 may also include the structural adhesive 56 contacting the battery cell coatings 72 corresponding to the battery cells 14. Further still, the first coating and adhesive assembly 16 may include a portion of an enclosure coating 74 extending between (and/or contacting) the first wall 24 of the enclosure and the structural adhesive 56. As will be described with reference to later drawings, the enclosure coating 74 may include an electrocoating layer, a powder coating layer, or both. In general, one or more materials may be selected for the enclosure coating 74 such that the enclosure coating 74 includes a shear strength greater than 6 MPa (e.g., 6-10 MPa) and a peel strength greater than 3 Newtons per millimeter (N/mm) (e.g., 3-10 N/mm). Other embodiments in accordance with the present disclosure may differ.

The battery pack 10 may also include the second coating and adhesive assembly 18 extending from the second wall 26 of the enclosure 12 to the battery cells 14. The above-described battery cell coatings 72 may form a portion of the second coating and adhesive assembly 18. Further, the thermal adhesive 58 of the second coating and adhesive assembly 18 may contact the battery cell coatings 72. Further still, a portion of the enclosure coating 74 may extend between (and/or contact) the second wall 26 of the enclosure 12 and the thermal adhesive 58. The heat exchanger 34 may be formed in or otherwise attached to the second wall 26 of the enclosure 12, such that the thermal adhesive 58 of the second coating and adhesive assembly 18 promotes heat transfer from the battery cells 14 to the heat exchanger 34. As shown, the heat exchanger 34 may be configured to receive a heat exchanger fluid 76, such as a coolant or refrigerant, configured to remove and expel heat from the battery pack 10. In some embodiments, the heat exchange fluid 76 may be routed to a heat sink or heat exchanger configured to remove or extract heat from the heat exchange fluid 76, prior to returning the heat exchange fluid 76 to the heat exchanger 34 of the battery pack 10.

In general, the first coating and adhesive assembly 16 may be configured to structurally couple the battery cells 14 to the first wall 24 of the enclosure 12. Indeed, certain portions of the first coating and adhesive assembly 16 extending from the first wall 24 of the enclosure 12 to the battery cell(s) 14 may be substantially devoid of gaps. One such portion 78 is illustrated in FIG. 3. Likewise, the second coating and adhesive assembly 18 may be configured to structurally couple the battery cells 14 to the second wall 26 of the enclosure 12. Indeed, certain portions of the second coating and adhesive assembly 18 extending from the second wall 26 of the enclosure 12 to the battery cell(s) 14 may be substantially devoid of gaps. One such portion 80 is illustrated in FIG. 3. Each of the substantially continuous portions 78, 80 (e.g., substantially devoid of gaps) may enable the battery pack 10 to support mechanical load(s) 36 against the first wall 24 and/or the second wall 26 of the enclosure 12. The mechanical load 36 may be, for example, loads associated with a vehicle (e.g., a weight of a seat, a weight of an occupant, dynamic loads associated with movement of the vehicle, etc.). Additionally or alternatively, disclosed features may be configured to increase a strength of the battery pack 10 against mechanical loads 36 by up to four times that of traditional configurations. These features improve integration of the battery pack 10 with a system (e.g., automobile, boat, lawnmower, etc.) being powered by the battery pack 10 (e.g., by enabling positioning of the battery pack 10 in various locations that may receive mechanical loads against the battery pack 10).

Further, the first coating and adhesive assembly 16 and the second coating and adhesive assembly 18 may be configured to electrically isolate the battery cells 14 from the first wall 24 (e.g., lid) of the enclosure 12 and the second wall 26 of the enclosure 12, respectively. For example, dielectric/insulative materials may be employed in the enclosure coating 74, the battery cell coatings 72, the structural and thermal adhesives 56, 58, or any combination thereof.

FIG. 4 is a blown up cross-sectional view of the first coating and adhesive assembly 16 of the battery pack 10 of FIG. 1. In the illustrated embodiment, the first coating and adhesive assembly 16 includes the enclosure coating 74 disposed on the first wall 24 (e.g., lid) of the enclosure 12. The enclosure coating 74 may include, for example, an electrocoating layer 90 contacting the first wall 24 of the enclosure 12 and a powder coating layer 92 contacting the electrocoating layer 90, such that the electrocoating layer 90 is between the first wall 24 and the powder coating layer 92. In some embodiments, all or substantially all inner surfaces of the enclosure 12 may include the electrocoating layer 90, whereas the powder coating layer 92 may only be included in select areas, such as on the first wall 24 in the illustrated embodiment and the second wall 26 referenced with respect to FIGS. 1-3. The electrocoating layer 90 may be applied via an immersion finishing process in which electrical current is employed to attract particles of the electrocoating layer 90 to the enclosure 12 (e.g., to the first wall 24). The powder coating layer 92 may be applied on the electrocoating layer 90 via polymer resin materials, curatives, additives, and/or other materials. Further, in certain embodiments of the present disclosure, the enclosure coating 74 may include a trivalent chromate conversion film, zirconium pre-treatment, high edge powder coat, or spray epoxy.

As previously described, the first coating and adhesive assembly 16 may also include the structural adhesive 56 disposed between (e.g., contacting) the enclosure coating 74, such as the powder coating layer 92 of the enclosure coating 74, and the battery cell coating 72 disposed about the can 70 of the battery cell 14. Further, the battery cell coating 72 (or a portion thereof) may be considered a part of the first coating and adhesive assembly 16 illustrated in FIG. 4.

Thicknesses and materials employed in the first coating and adhesive assembly 16, the enclosure 12, and the battery cell 14 may be selected to enable the battery pack to support mechanical loads against the enclosure 12 (e.g., the first wall 24), and to facilitate electrical isolation of the battery cells 14 from the enclosure 12, as previously described. With respect to electrical isolation, for example, the electrocoating layer 90 may include a resistivity of 200-4000 Megaohms (MΩ), the powder coating layer 92 may include a resistivity of 200-4000 Megaohms (MΩ), the structural adhesive 56 may include a resistivity of 25-50 Megaohms (MΩ), and the cell coating 72 may include a resistivity of 200-4000 Megaohms (MΩ). Other embodiments in accordance with the present disclosure may differ.

Further, it should be noted that thicknesses of the various features illustrated in FIG. 4 should not be taken as representative of accurate scale. In accordance with the present disclosure, the first wall 24 (e.g., lid) of the enclosure 12 may include a first thickness 93, the enclosure coating 74 may include a second thickness 94, the structural adhesive 56 may include a third thickness 96, the cell coating 72 may include a fourth thickness 98, and the can 70 of the battery cell 14 may include a fifth thickness 100. In some embodiments, the first thickness 93 may be approximately 1-3 millimeters (mm), the second thickness 94 may be approximately 0.1-0.25 mm, the third thickness 96 may be approximately 0.5-5 mm, the fourth thickness 98 may be approximately 0.05-0.2 mm, and the fifth thickness 100 may be approximately 0.2-0.4 mm. It should be noted that presently disclosed embodiments may be scaled to larger or smaller sizes. For example, in general, the fourth thickness 98 may be approximately 25-75% of the fifth thickness 100, the third thickness 96 may be approximately 200-400% of the fifth thickness 100, the second thickness 94 may be approximately 25-100% of the fifth thickness 100, and the first thickness 93 may be approximately 500-900% of the fifth thickness 100. Other embodiments in accordance with the present disclosure may differ.

As described above, FIG. 4 illustrates the first coating and adhesive assembly 16 extending between the first wall 24 (e.g., lid) of the enclosure 12 and the battery cell(s) 14. The second coating and adhesive assembly 18, illustrated in FIGS. 1-3, may include the same or similar structure, with the exception that the structural adhesive 56 of the first coating and adhesive assembly 16 would be replaced by the thermal adhesive 58 of the second coating and adhesive assembly 18 illustrated in FIGS. 1-3. With reference to FIGS. 3 and 4, as previously described, the structural adhesive 56 and the thermal adhesive 58 may include the same or similar materials in some embodiments. In other embodiments, the structural adhesive 56 may include a material composition different than the thermal adhesive 58. In general, the adhesives 56, 58 may include materials selected from 2 component polyurethanes (2KPU), 2 component acrylics (2K acrylic), or 2 component epoxy (2k epoxy). Further, the structural adhesive 56 or corresponding material may include a thermal conductivity (i.e., K-value) between 0.1 and 1.0, 0.15 and 0.6, or 0.2 and 0.4, a strength (e.g., shear strength) greater than 6 MPa (e.g., 6-10 MPa), and an elongation percentage between 50% and 200% or between 100% and 175%. Additionally or alternatively, the thermal adhesive 58 or corresponding material may include a thermal conductivity (i.e., K-value) between 0.2 and 2.0, 0.3 and 1.5, or 0.4 and 1.0, a strength (e.g., shear strength) greater than 6 MPa (e.g., 6-10 MPa), and an elongation percentage between 50% and 150% or between 75% and 125%.

FIG. 5 is an exploded perspective view of an embodiment of one of the battery cells 14 of the battery pack 10 of FIG. 1. In the illustrated embodiment, the battery cell coating 72 is disposed about the can 70 of the battery cell 14. As shown, the battery cell coating 72 may include a first coating segment 110, a second coating segment 112, a third coating segment 114, and a fourth coating segment 116. The first coating segment 110 and the second coating segment 112 may include a first set of common characteristics (e.g., material composition, surface preparation, adhesive films, tensile and/or lap shear strength, etc.), and the third coating segment 114 and the fourth coating segment 116 may include a second set of common characteristics (e.g., material composition, surface preparation, adhesive films, tensile and/or lap shear strength, etc.).

In general, the first coating segment 110 may form a part of the first coating and adhesive assembly 16 illustrated in FIGS. 1-4, and the second coating segment 112 may form a part of the second coating and adhesive assembly 16 illustrated in FIGS. 1-3. For these reasons, the first coating segment 110 and the second coating segment 112 having the first set of common characteristics may be of a higher quality than the third coating segment 114 and the fourth coating segment 116 having the second set of common characteristics. For example, the first coating segment 110 and the second coating segment 112 may include a higher tensile strength, better T-peel test performance, better lap shear strength, better electrical isolation, or any combination thereof relative to the third coating segment 114 and the fourth coating segment 116. Thus, the battery cell coating 72 may be designed to contribute to the mechanical support and electrical isolation described with respect to earlier drawings, while reducing or conserving cost (e.g., by way of the lower quality third coating segment 114 and fourth coating segment 116).

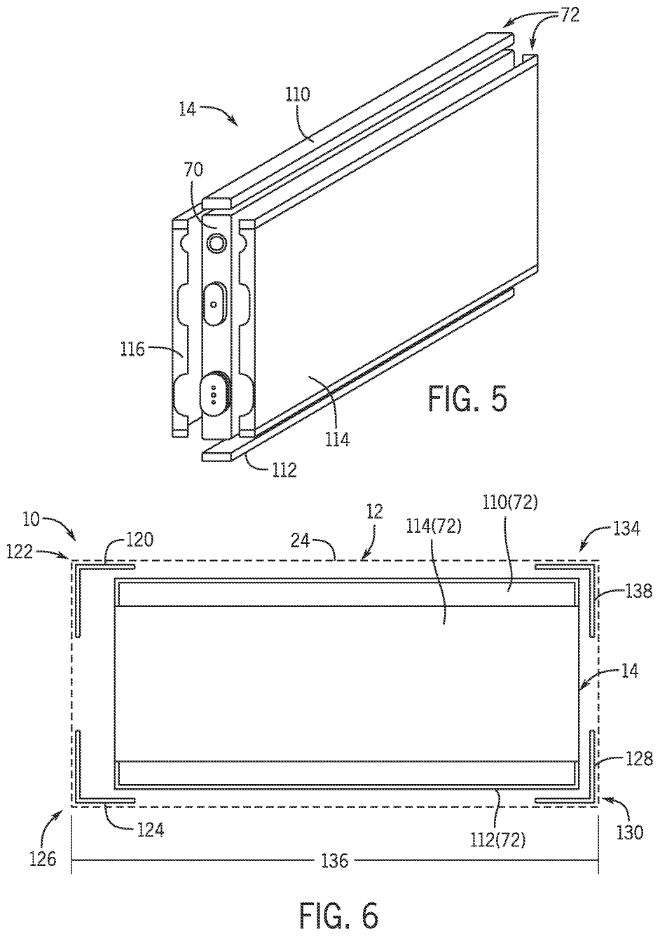

FIG. 6 is a schematic cross-sectional view of an embodiment of a portion of the battery pack 10 of FIG. 1, including the battery cell 14 of FIG. 5. In the illustrated embodiment, the first segment 110, second segment 112, and third segment 114 of the battery cell coating 72 is shown. The fourth segment 116 illustrated in FIG. 5 is hidden due to the illustrated perspective. Further, the battery cell 14 is disposed within the enclosure 12.

As previously described, at least certain portions of the enclosure 12 (e.g., the first wall 24 or lid) may include aluminum or aluminum alloy, such as 5182 aluminum alloy. Further, PET may be employed in selected areas of the enclosure 12 in place of portions of the adhesives described with respect to FIGS. 1-4 as a cost savings measure, without affecting the mechanical strength of the enclosure 12 and/or electrical isolation of the battery cell 14 from the enclosure 12.

For example, a first segment 120 of PET may be disposed in a first corner 122 of the enclosure 12, a second segment 124 of PET may be disposed in a second corner 126 of the enclosure 12, a third segment 128 of PET may be disposed in a third corner 130 of the enclosure 12, and a fourth segment 132 of PET may be disposed in a fourth corner 134 of the enclosure 12. As shown, portions of the first segment 120 and the second segment 124 of PET may overlap with portions of the first segment 110 and the second segment 112 of the battery cell coating 72 along a dimension 136 of the battery pack 10. Likewise, portions of the third segment 128 and the fourth segment 132 of PET may overlap with portions of the first segment 110 and the second segment 112 of the battery cell coating 72.

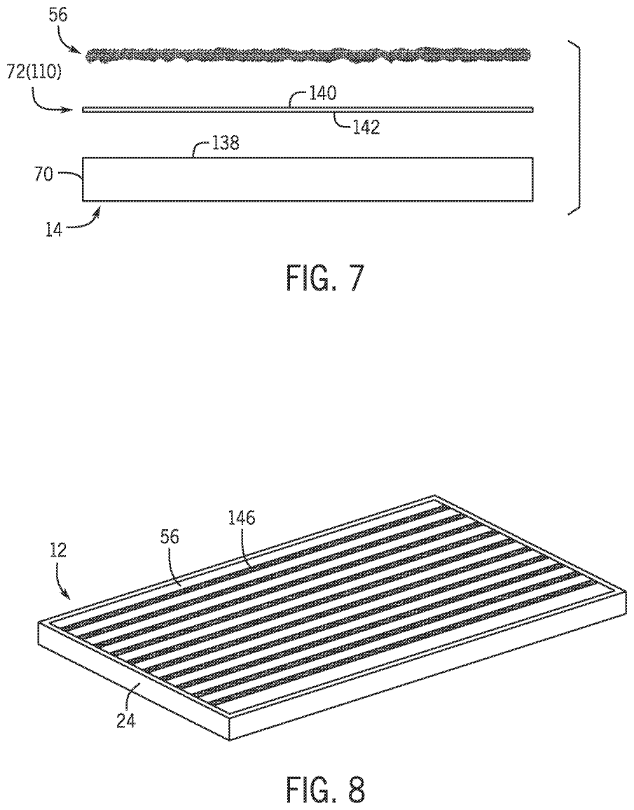

FIG. 7 is an exploded side view of an embodiment of a portion of the battery pack of FIG. 1, including a portion of one of the battery cells 14 (e.g., a portion of the can 70), a portion of the battery cell coating 72 (e.g., the first segment 110 in FIG. 5), and a portion of adhesive (e.g., the structural adhesive 56). In the illustrated embodiment, an outer surface 138 of the can 70 of the battery cell 14 may include a surface preparation configured to improve adhesion of the first segment 110 of the battery cell coating 72 to the can 70. For example, the surface preparation may include a mechanical abrasion and/or laser etching. Further, a first surface 140 of the first segment 110 of the battery cell coating 72 may include a surface preparation (e.g., laser etching, primer or plasma pre-treatment, etc.) configured to improve adhesion between the first segment 110 of the battery cell coating 72 and the adhesive (e.g., structural adhesive 56) thereto. Further still, an ultraviolet (UV)-activated adhesive may be disposed along a second surface 142 of the first segment 110 of the battery cell coating 72, the second surface 142 opposing the first surface 140.

It should be noted that, in certain embodiments, some or all of the above-described surface preparation and/or UV-activated adhesive features may only be employed for both the first segment 110 and the second segment 112 of the battery cell coating 72 illustrated in FIG. 5, but not the third segment 114 and the fourth segment 116 in FIG. 5. In some embodiments, for the third segment 114 and the fourth segment 116 of the battery cell coating 72 in FIG. 5, a pressure-sensitive adhesive (PSA) may be employed in lieu of the above-described UV-activated adhesive features corresponding to the first segment 110 and the second segment 112 of the battery cell coating 72.

FIG. 8 is a perspective view of an embodiment of the first wall 24 (e.g., lid) of the enclosure 12 of the battery pack 10 of FIG. 1. An underside of the first wall 24 is shown in the illustrated perspective. Further, the enclosure coating is hidden in the illustrated perspective by the structural adhesive 56 and gap control strips 146 extending longitudinally across the underside of the first wall 24. The gap control strips 146 may be employed to reduce undesirable elongation of the structural adhesive 56 in response to various mechanical loads described with reference to previous drawings and/or in response to assembly of the battery pack 10. The gap control strips 146 may also prevent Y-capacitance in excess of safety regulations.

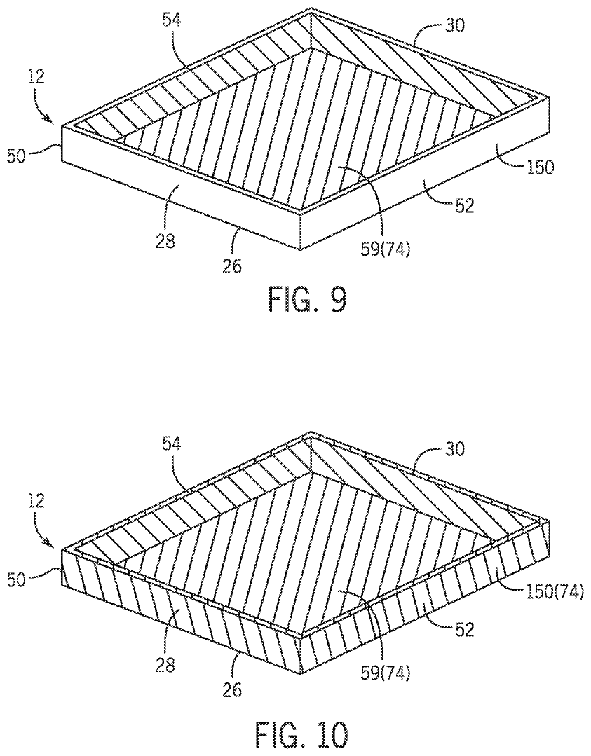

FIG. 9 is a perspective view of an embodiment of the base 50 of the enclosure 12 of the battery pack 10 of FIG. 1, in which portions of the base 50 are partially coated with the enclosure coating 74. As previously described, the base 50 may be formed by the second wall 26 (e.g., having a heat exchanger formed therein or attached thereto), the third wall 28, the fourth wall 30, the fifth wall 52, and the sixth wall 54. In the illustrated embodiment, the inward facing surfaces 59 of the base 50 are coated with the enclosure coating 74. In the illustrated embodiment, outward facing surfaces 150 of the base 50 are not coated with the enclosure coating 74. FIG. 10 is a perspective view of an embodiment of the base 50 of the enclosure 12 of the battery pack 10 of FIG. 1, in which the base 50 is coated with the enclosure coating 74. Indeed, both the inward facing surfaces 59 and the outward facing surfaces 150 are coated with the enclosure coating 74 in FIG. 10.

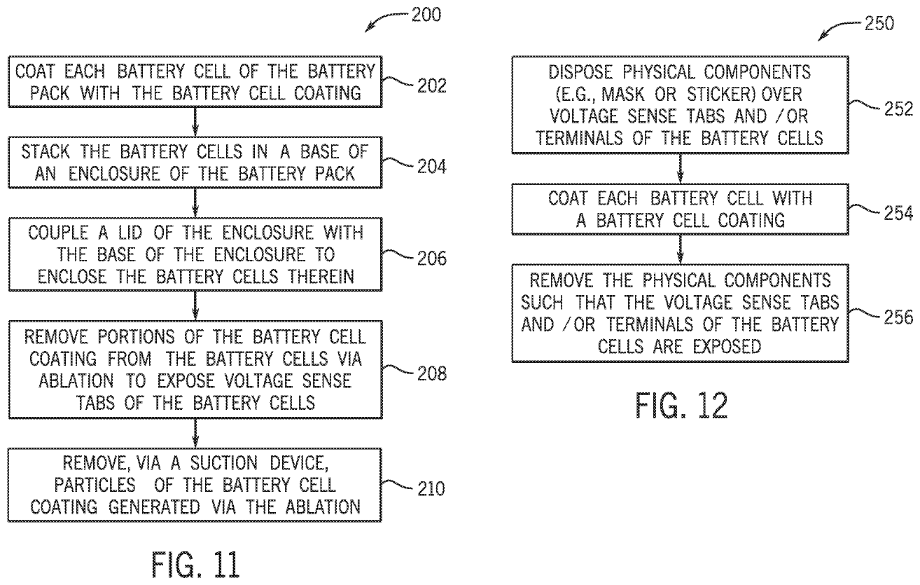

FIG. 11 is a process flow diagram illustrating an embodiment of a method 200 of manufacturing and assembly portions of the battery pack 10 of FIG. 1. In the illustrated embodiment, the method 200 includes coating (block 202) each battery cell 14 of the battery pack 10 with a corresponding battery cell coating 72. An example of the battery cell 14 and corresponding battery cell coating 72 is provided in FIG. 5.

The method 200 also includes stacking (block 204) the battery cells 14 in the base 50 of the enclosure 12 of the battery pack 10, and coupling (block 206) the lid 24 of the enclosure 12 with the base 50 to enclose the battery cells 14 therein. An example of this arrangement (e.g., the base 50, the lid 24, the battery cells 14) can be found in FIG. 2. The method 200 also includes removing (block 208) portions of the battery cell coatings 72 from the battery cells 14 via ablation to expose the voltage sense tabs 55 of the battery cells 14. For example, openings in the lid 24 may enable ablation tools to access the battery cells 14 from a position external to the battery pack 10, such that the ablation tools may remove portions of the battery cell coatings 72 from areas corresponding to the voltage sense tabs 55. In some embodiments, the method 200 also includes removing (block 210), via a suction device, particles of the battery cell coating 72 generated via the ablation.

FIG. 12 is a process flow diagram illustrating an embodiment of a method 250 of manufacturing and assembling portions of the battery pack 10 of FIG. 1. In the illustrated embodiment, the method 250 includes disposing (block 252) physical components (e.g., a mask, a device, a sticker) over the voltage sense tabs 55 and/or the terminals 20, 22 of the battery cells 14. The method 250 also includes coating (block 254) each battery cell 14 with the battery cell coating 72. In some embodiments, block 254 may include coating (e.g., spraying) various layers or patterns of the battery cell coating 72 on the battery cell 14. The method 250 also includes removing (block 256) the physical components such that the voltage sense tabs 55 and/or terminals 20, 22 of the battery cells 14 are exposed. The physical components may serve to prevent the coating 72 from being applied to the voltage sense tabs 55 and/or the terminals 20, 22. In this way, the terminals 20, 22 may be coupled with bus bars and the voltage sense tabs 55 may be coupled with a printed circuit board (PCB).

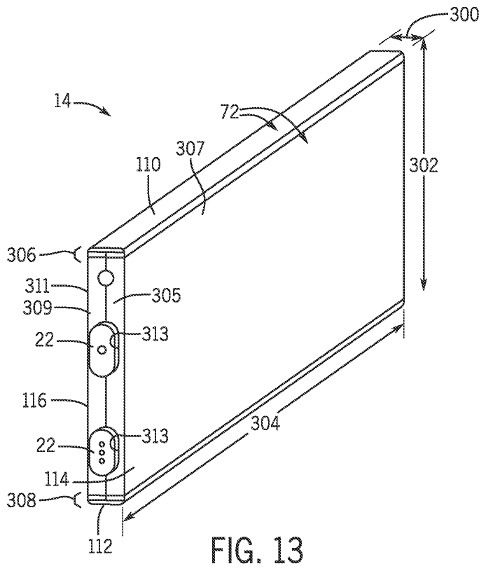

FIG. 13 is a perspective view of an embodiment of the battery cell 14 of FIG. 5 in an assembled form. As previously described, the battery cell 14 includes various componentry forming the battery cell coating 72 about the can 70 (shown in FIG. 5 but hidden from view in FIG. 13) of the battery cell 14. For example, the battery cell coating 72 includes the first coating segment 110, the second coating segment 112, the third coating segment 114, and the fourth coating segment 116. As previously described, the first coating segment 110 and the second coating segment 112 may include common characteristics (e.g., material composition, surface preparation, adhesive films, tensile and/or lap shear strength, etc.), and the third coating segment 114 and the fourth coating segment 116 may include common additional characteristics (e.g., material composition, surface preparation, adhesive films, tensile and/or lap shear strength, etc.). In general, the first coating segment 110 and the second coating segment 112 may include higher quality characteristics (e.g., greater strength and/or resiliency) than then the third coating segment 114 and the fourth coating segment 116.

In the illustrated embodiment, the battery cell 14 includes a first dimension 300 (referred to below as the width dimension), a second dimension 302 (referred to below as the height dimension), and a third dimension 304 (referred to below as the length dimension). The length dimension 304 is greater than the height dimension 302, and the height dimension 302 is greater than the width dimension 300. The first coating segment 110 and the second coating segment 112 extend in planes defined by the width dimension 300 and the length dimension 304, whereas the third coating segment 114 and the fourth coating segment 116 extend in planes defined by the width dimension 300 and the length dimension 304. In this way, the third coating segment 114 and the fourth coating segment 116 are generally larger (e.g., larger surface areas) than the first coating segment 110 and the second coating segment 112. Additionally, the third coating segment 114 includes a first portion 305 (e.g., a first flange) extending from a body 307 of the third coating segment 114 toward the fourth coating segment 116, the fourth coating segment 116 includes a second portion 309 (e.g., a second flange) extending from a body 311 of the fourth coating segment 116 toward the third coating segment 114, and the terminals 22 of the battery cell 14 extend through gaps 313 formed between the first portion 305 (e.g., first flange) and the second portion 309 (e.g., second flange).

A benefit of the high quality characteristics of the first coating segment 110 and the second coating segment 112 is more pronounced in the positions illustrated in FIGS. 5 and 13 and described in detail above. For example, in the illustrated positions, the first coating segment 110 forms a portion of the first coating and adhesive assembly 16 illustrated in at least FIGS. 3 and 4, and the second coating segment 112 forms a portion of the second coating and adhesive assembly 18 illustrated in at least FIG. 3. Thus, the first coating segment 110 and the second coating segment 112 extend tangential to a direction of the mechanical load 36 in FIG. 3 and provide structural support to the battery pack 10 in FIG. 3 against the mechanical load 36, among other possible loading conditions. Further, because the first coating segment 110 and the second coating segment 112 are smaller than the third coating segment 114 and the fourth coating segment 116 (e.g., smaller total surface areas) as shown and described above, a cost associated with obtaining the above-described benefits is reduced or otherwise mitigated.

In the embodiment illustrated in FIG. 13, each of the third coating segment 114 and the fourth coating segment 116 may overwrap a portion of the first coating segment 110 and an additional portion of the second coating segment 112. For example, as shown in FIG. 13, a portion 306 (hidden from view) of the first coating segment 110 is overwrapped by the third coating segment 114 and the fourth coating segment 116, and a portion 308 (hidden from view) of the second coating segment 112 is overwrapped by the third coating segment 114 and the fourth coating segment 116. Thus, the portion 306 of the first coating segment 110 is between the can 70 (illustrated in FIG. 5) and the third and fourth coating segments 114, 116, and the portion 308 of the second coating segment 112 is between the can 70 (illustrated in FIG. 5) and the third and fourth coating segments 114, 116. In some embodiments, the first coating segment 110 and the second coating segment 112 are integrated in the battery cell 14 first, and then the third coating segment 114 and the fourth coating segment 116 are integrated in the battery cell 14 second, such that the third coating segment 114 and the fourth coating segment 116 overwrap the portions 306, 308 of the first coating segment 110 and the second coating segment 112, respectively. In this way, the can 70 (illustrated in FIG. 5) of the battery cell 14 is not exposed to an environment surrounding the battery cell 14, which may improve dielectric protection and/or electrical isolation or resistance. Other arrangements are also possible, as described in detail below with reference to the drawings.

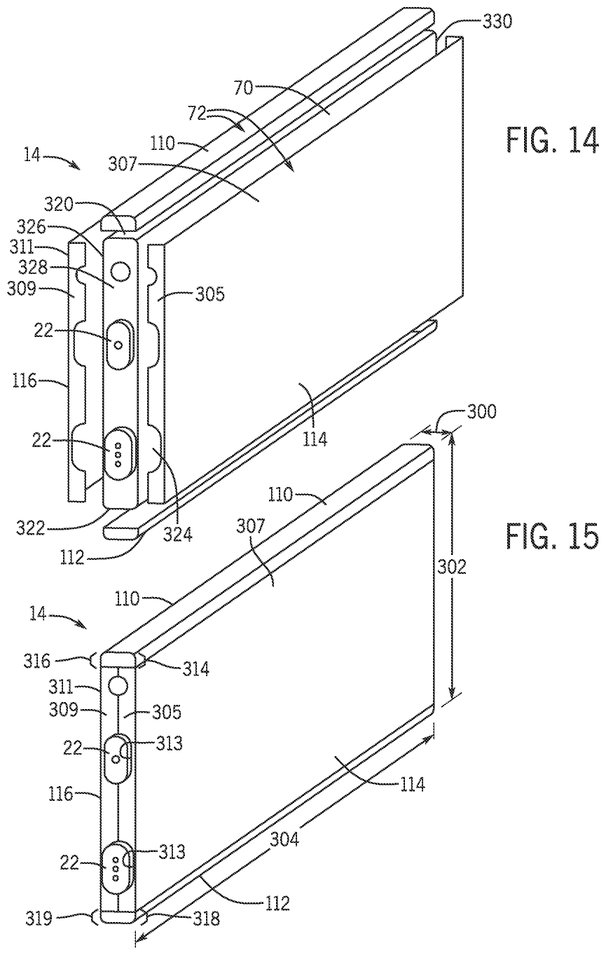

FIG. 14 is an exploded perspective view of an embodiment of the battery cell 14 of the battery pack 10 of FIG. 1, and FIG. 15 is a perspective view of an embodiment of the battery cell 14 of FIG. 14 in an assembled form. The battery cell 14 illustrated in FIGS. 14 and 15 may be similar to the battery cell 14 illustrated in FIGS. 5 and 13, except that, in FIGS. 14 and 15, the first coating segment 110 overwraps the third coating segment 114 and the fourth coating segment 116, and the second coating segment 112 overwraps the third coating segment 114 and the fourth coating segment 116. For example, in FIGS. 14 and 15, the third coating segment 114 and the fourth coating segment 116 may be disposed on the can 70 of the battery cell 14 first, and then the first coating segment 110 and the second coating segment 112 may be disposed on the can second, such that the first coating segment 110 overwraps a first portion 314 (hidden from view) of the third coating segment 114 and a second portion 316 (hidden from view) of the fourth coating segment 116, and the second coating segment 110 overwraps a first additional portion 318 (hidden from view) of the third coating segment 114 and a second additional portion 319 (hidden from view) of the fourth coating segment 114. It should be noted that the first portion 314 and the first additional portion 318 of the third coating segment 114 extends across both the body 307 and the flange 305 of the third coating segment 114, and the second portion 316 and the second additional portion 319 of the fourth coating segment 116 extends across both the body 311 and the flange 309 of the fourth coating segment 116.

As shown in FIG. 14, the can 70 of the battery cell 14 includes a first side 320 aligned with the first coating segment 110, a second side 322 opposing the first side 320 and aligned with the second coating segment 112, a third side 324 aligned with the third coating segment 114, a fourth side 326 opposing the third side 324 and aligned with the fourth coating segment 116, a fifth side 328 extending from the first side 320, the second side 322, the third side 324, and the fourth side 326, and a sixth side 330 opposing the fifth side 328 and extending from the first side 320, the second side 322, the third side 324, and the fourth side 326. Although not denoted in FIG. 5, it should be understood that the can 70 in FIG. 5 may include the same or similar sides 320, 322, 324, 326, 328, 330 described above with respect to the can 70 in FIG. 14. Either of the above-described overlap techniques (e.g., described with respect to FIGS. 13 and 15) may operate to electrically isolate the various sides 320, 322, 324, 326, 328, 330 of the can 70 of the battery cell 14 from an external environment around the battery cell 14.

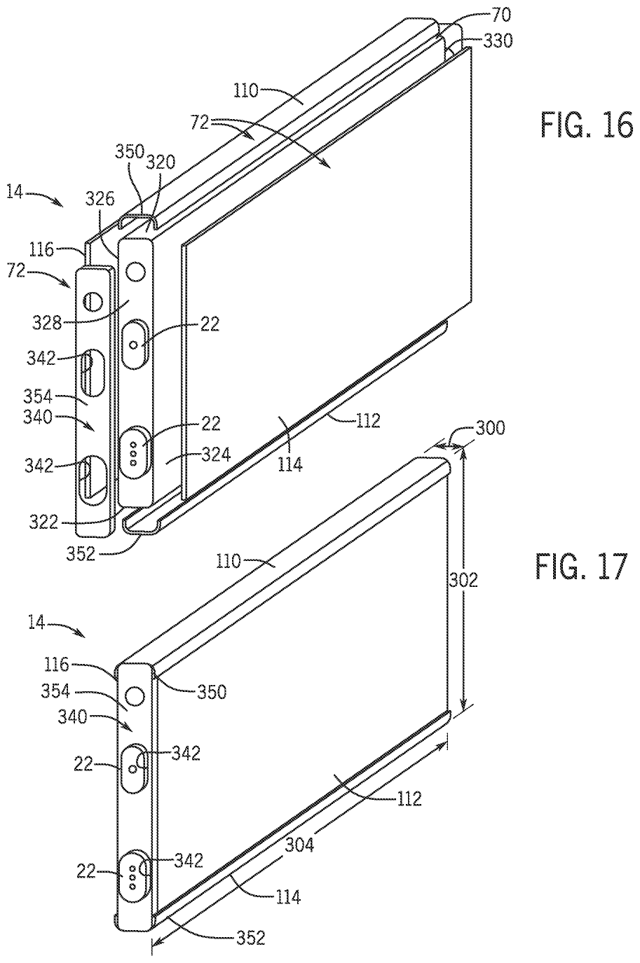

FIG. 16 is an exploded perspective view of an embodiment of the battery cell 14 of the battery pack 10 of FIG. 1, including an end cap 340 having apertures 342 configured to receive the terminals 22 of the battery cell 14, and FIG. 17 is a perspective view of an embodiment of the battery cell 14 of FIG. 16 in an assembled form. For example, the end cap 340 may be employed in lieu of the portions 305, 309 (e.g., flanges) of the third and fourth coating segments 114, 116, respectively, illustrated at least in FIGS. 13-15. In some embodiments, the end cap 340 may be disposed on the fifth side 328 of the can 70 first, and then the third and fourth coating segments 114, 116 are disposed on the third and fourth side 324, 326, respectively, of the can 70 second, and then the first and second coating segments 110, 112 are disposed on the first and second sides 320, 322, respectively, of the can 70 third. It should be noted that “can” as used herein (e.g., the can 70) may refer to any housing, pouch, or enclosure generally associated with a battery cell and configured to enclose componentry of the battery cell (e.g., electrolyte, electrodes, a separator, etc.). It should be noted that, while a sixth side of the can 70 is hidden in the illustrated perspective, an additional end cap may be disposed on the sixth side of the can 70, and/or additional portions (e.g., flanges) of the third and fourth coating segments 114, 116 may extend onto the sixth side of the can 70.

The above-described ordering may enable the first coating segment 110 to overlap with (e.g., overwrap) the third coating segment 114, the fourth coating segment 114, and the end cap 340, and the second coating segment 112 to overlap with (e.g., overwrap) the third coating segment 114, the fourth coating segment 114, and the end cap 340. In the illustrated embodiment, a first front edge 350 of the first coating segment 110 and a second front edge 352 of the second coating segment 112 may include an open-ended U-shape such that the first coating segment 110 and the second coating segment 112 do not wrap around a front facing surface 354 of the end cap 340.

It should be noted that in the embodiment illustrated in FIGS. 16 and 17, a material composition of the first and second coating segments 110, 112 may include a relatively high quality polyethylene terephthalate (PET), ultraviolet (UV) cured pressure-sensitive adhesive (PSA), and primer, whereas a material composition of the third and fourth coating segments 114, 116 may include a relatively low quality PET and PSA (e.g., without UV curing and/or without primer). Technical benefits of these material compositions as they relate to the positioning of the various coating segments 110, 112, 114, 116 is described in detail above with respect to earlier drawings.

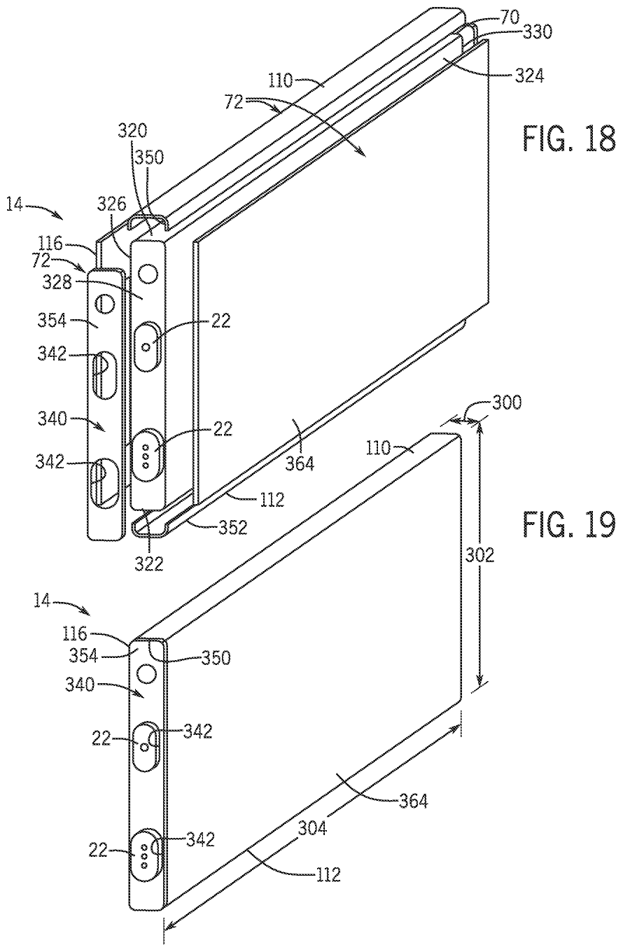

FIG. 18 is an exploded perspective view of an embodiment of the battery cell 14 of the battery pack 10 of FIG. 1, including the end cap 340 with the apertures 342 configured to receive the terminals 22 of the battery cell 14, and including at least one thermal insulation or gap pad 364. FIG. 19 is a perspective view of an embodiment of the battery cell 14 of FIG. 18 in an assembled form. In FIGS. 18 and 19, the thermal insulation or gap pad 364 is employed in lieu of the third coating segment 114 illustrated in earlier drawings and described above. For example, as previously described, the third coating segment 114 illustrated in earlier drawings may include a material composition having PET and other possible materials, such as PSA. The thermal insulation or gap pad 364 may be devoid of PET and instead employ other thermally insulative materials. Further, the thermal insulation or gap pad 364 may reduce or eliminate the need for UV coating on the third side 324 and the fourth side 326 (e.g., broad faces) of the can 70 of the battery cell 14.

While the illustrated embodiment includes the fourth coating segment 114, in other embodiments, the fourth coating segment 114 may be replaced by an additional instance of the thermal insulation or gap pad 364. It should be noted that, in certain embodiments associated with FIGS. 18 and 19, the first coating segment 110 and the second coating segment 112 may overwrap a portion of the thermal insulation or gap pad 364, while in other embodiments, the thermal insulation or gap pad 364 may overlap portions of the first coating segment 110 and the second coating segment 112. It should be noted that the thermal insulation or gap pad 364 may still be considered a segment or portion of the battery cell coating 72, but that it is referred to as the thermal insulation or gap pad 364 because it does not include PET.

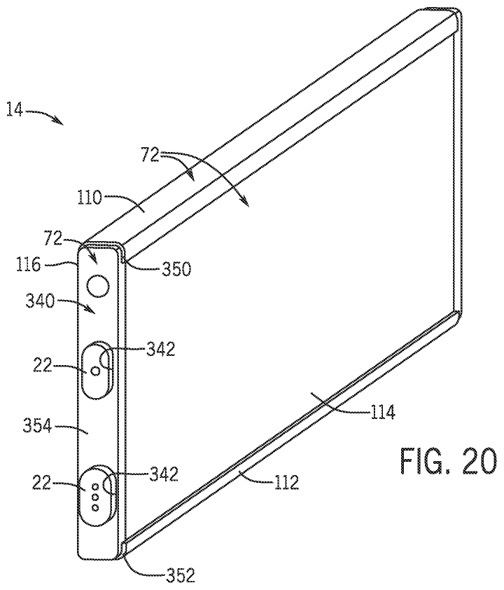

FIG. 20 is a perspective view of an embodiment of the battery cell 14 of the battery pack 10 of FIG. 1, including UV cured spray acrylic in at least a portion of the battery cell coating 72 of the battery cell 14. For example, the first coating segment 110 and the second coating segment 112 may include the UV cured spray acrylic and/or UV PSA with primer. The end cap 340, the third coating segment 114, and the fourth coating segment 116 may include similar material compositions as previously described, such as less expensive PET and PSA. In some embodiments, the end cap 340, the third coating segment 114, and the fourth coating segment 116 may include UV coating applied to the can 70 before the first coating segment 110 and the second coating segment 112 are applied to the can 70.

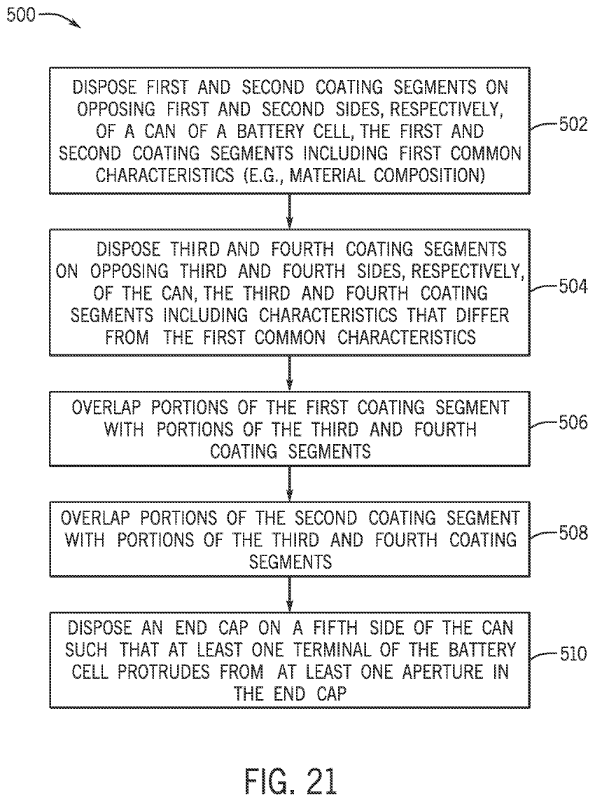

FIG. 21 is a process flow diagram illustrating an embodiment of a method 500 of manufacturing a battery cell of the battery pack of FIG. 1. It should be noted that an ordering of the steps (e.g., blocks) of the method 500 below should not be taken to imply that the method 500 must be performed in such order. Indeed, the steps (e.g., blocks) of the method 500 may be performed in any other suitable order in accordance with the present disclosure. Further, in some embodiments, the method 500 may not include one of the steps (e.g., blocks) illustrated in FIG. 21. As an example, in some embodiments, block 510 (described in detail below) is excluded.

In the illustrated embodiment, the method 500 includes disposing (block 502) first and second coating segments on opposing first and second sides, respectively, of a can of a battery cell, the first and second coating segments including first common characteristics (e.g., material composition). The common characteristics may be, for example, a common material composition, common structural qualities (e.g., strength qualities), common surface preparations, etc. In general, the first and second coating segments may be a relatively high quality as they are employed in an assembly configured to provide structural support against mechanical loads (e.g., external mechanical loads) on the battery pack in which the battery cell is disposed.

The method 500 also includes disposing (block 504) third and fourth coating segments on opposing third and fourth sides, respectively, of the can, the third and fourth coating segments including characteristics that differ from the first common characteristics. In one embodiment, the third and fourth coating segments include second common characteristics that differ from the first common characteristics. In another embodiment, the third coating segment and the fourth coating segment include differing characteristics. For example, the third coating segment may include a material composition, and the fourth coating segment (e.g., a thermal insulation or gap pad) may include an additional material composition different than the material composition of the third coating segment.

The method 500 also includes overlapping (block 506) portions of the first coating segment with portions of the third and fourth coating segments, and overlapping (block 508) portions of the second coating segment with portions of the third and fourth coating segments. It should be noted that blocks 506 and 508 may be performed as the coating segments are applied to the can of the battery cell (e.g., as outlined in blocks 502 and 504 described above). In some embodiments, the first and second coating segments are disposed on the can first, and then the third and fourth coating segments are disposed on the can second, such that the third and fourth coating segments overwrap the first and second coating segments. In other embodiments, the third and fourth coating segments are disposed on the can first, and then the first and second coating segments are disposed on the can second, such that the first and second coating segments overwrap the third and fourth coating segments. Other arrangements and techniques are also possible.

The method also includes disposing (block 510) an end cap on a fifth side of the can such that at least one terminal of the battery cell protrudes from at least one aperture in the end cap. In some embodiments, the end cap includes similar or the same characteristics (e.g., material composition) as the third and fourth coating segments. Thus, the end cap may be considered a fifth coating segment. Further, in some embodiments, no end cap is employed. In such embodiments, the third and fourth coating segments may include respective bodies disposed on the third and fourth sides of the can, and respective portions (e.g., respective flanges) extending transverse to the respective bodies, where the respective portions (e.g., respective flanges) contact (e.g., cover) the fifth side of the can. Additionally, or alternatively, a sixth side of the can may be covered by an additional end cap and/or by additional respective portions (e.g., additional respective flanges) of the third and fourth coating segments. In this way, the can of the battery cell is fully or mostly coated, improving electrical insulation and/or resistance.

The present disclosure is directed toward various embodiments of a battery pack that provide various technical benefits over traditional systems and methods, including improved support against mechanical loads, improved electrical isolation of battery cells of the battery pack from an enclosure of the battery pack, and reduced cost, among other benefits.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery cell, comprising:
a can in which componentry of the battery cell is enclosed; and
a coating disposed on the can, the coating comprising:
a first segment comprising a first material composition;
a second segment separate from the first segment and comprising the first material composition;
a third segment extending between the first segment and the second segment and comprising a second material composition different than the first material composition; and
a fourth segment separate from the third segment, extending between the first segment and the second segment, and comprising the second material composition.

2. The battery cell of claim 1, wherein the first segment contacts a first side of the can and the second segment contacts a second side of the can opposing the first side of the can.

3. The battery cell of claim 2, wherein the third segment contacts a third side of the can, the fourth segment contacts a fourth side of the can opposing the third side, the third side extends from the first side to the second side, and the fourth side extends from the first side to the second side.

4. The battery cell of claim 3, comprising an end cap having the second material composition or a third material composition different than the first material composition and the second material composition, the end cap contacting a fifth side of the can extending between the first side, the second side, the third side, and the fourth side.

5. The battery cell of claim 4, comprising at least one terminal extending through at least one aperture in the end cap.

6. The battery cell of claim 1, wherein the first segment overlaps with the third segment along a portion of the coating, and the first segment overlaps with the fourth segment along an additional portion of the coating.

7. The battery cell of claim 1, wherein the first material composition comprises an ultraviolet (UV) cured spray acrylic.

8. The battery cell of claim 1, wherein the first material composition comprises polyethylene terephthalate (PET), ultraviolet (UV) cured PSA, and primer.

9. The battery cell of claim 1, wherein the third segment comprises a thermal insulation or gap pad.

10. A battery pack comprising a plurality of battery cells, wherein each battery cell of the plurality of battery cells comprises:
a can in which componentry of the battery cell is enclosed; and
a coating disposed on the can, the coating comprising:
a first coating segment disposed on a first side of the can;
a second coating segment disposed on a second side of the can opposing the first side;
a third coating segment disposed on a third side of the can; and
a fourth coating segment disposed on a fourth side of the can opposing the third side, wherein a first portion of the first coating segment overlaps with the third coating segment, a first additional portion of the first coating segment overlaps with the fourth coating segment, a second portion of the second coating segment overlaps with the third coating segment, and a second additional portion of the second coating segment overlaps with the fourth coating segment.

11. The battery pack of claim 10, wherein the first coating segment and the second coating segment comprise a first material composition, and the third coating segment and the fourth coating segment comprises a second material composition different than the first material composition.

12. The battery pack of claim 10, wherein the coating comprises an end cap disposed on a fifth side of the can extending between the first side, the second side, the third side, and the fourth side.

13. The battery pack of claim 12, wherein the end cap comprises at least one aperture configured to receive at least one terminal of the battery cell.

14. The battery pack of claim 10, wherein the third coating segment comprises a first body and a first flange extending from the first body, the fourth coating segment comprises a second body and a second flange extending from the second body, and the first flange and the second flange are disposed on a fifth side of the can extending between the first side, the second side, the third side, and the fourth side.

15. The battery pack of claim 14, wherein the first flange and the second flange define at least one gap therebetween, and the at least one gap is configured to receive at least one terminal of the battery cell.

16. A battery cell, comprising:
a can in which componentry of the battery cell is enclosed; and
a coating disposed on the can, the coating comprising:
a first coating segment disposed on a first side of the can, wherein the first coating segment comprises a first material composition;
a second coating segment disposed on a second side of the can opposing the first side, wherein the second coating segment comprises the first material composition;
a third coating segment disposed on a third side of the can, wherein the third coating segment comprises a second material composition different than the first material composition; and
a fourth coating segment disposed on a fourth side of the can, wherein the fourth coating segment comprises the second material composition, a portion of the first coating segment overlaps with respective first portions of the third coating segment and the fourth coating segment, and an additional portion of the second coating segment overlaps with respective second portions of the third coating segment and the fourth coating segment.

17. The battery cell of claim 16, wherein:
the portion of the first coating segment is overwrapped by the respective first portions of the third coating segment and the fourth coating segment such that the portion is between the can and the respective first portions; and
the additional portion of the second coating segment is overwrapped by the respective second portions of the third coating segment and the fourth coating segment such that the additional portion is between the can and the respective second portions.

18. The battery cell of claim 16, wherein:
the respective first portions of the third coating segment and the fourth coating segment are overwrapped by the portion of the first coating segment such that the respective first portions are between the can and the portion; and
the respective second portions of the third coating segment and the fourth coating segment are overwrapped by the additional portion of the second coating segment such that the respective second portions are between the can and the additional portion.

19. The battery cell of claim 16, wherein:
the third coating segment comprises a flange contacting a fifth side of the can extending from the first side, the second side, the third side, and the fourth side;
the fourth coating segment comprises an additional flange contacting the fifth side; and
the battery cell comprises at least one terminal extending from the fifth side.

20. The battery cell of claim 16, wherein the first coating segment comprises a first surface area, the second coating segment comprises a second surface area, the third coating segment comprises a third surface area, the fourth coating segment comprises a fourth surface area, the first surface area is less than the third surface area, the first surface area is less than the fourth surface area, the second surface area is less than the third surface area, and the second surface area is less than the fourth surface area.
